(19) United States
(12) Patent Application Publication
(10) Pub. No.: US 2005/0175835 A1
(43) Pub. Date: Aug. 11, 2005

(54) Bicomponent fibers of syndiotactic polypropylene

(75) Inventors: Michael Musgrave, Houston, TX (US); Mohan R. Gownder, Austin, TX (US); Jay Nguyen, Pasadena, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/014,672

(22) Filed: Dec. 16, 2004

Related U.S. Application Data
(63) Continuation-in-part of application No. 10/731,729, filed on Dec. 9, 2003, now Pat. No. 6,864,331.

(51) Int. Cl. C08F 8/00

(52) U.S. Cl. 428/375; 442/361; 442/362; 442/415; 442/409

(57) ABSTRACT

Bicomponent fibers of syndiotactic polypropylene and ethylene-propylene random copolymer, can be prepared. The bicomponent fibers may exhibit self-crimp properties and high shrinkage characteristics.

### CROSS-REFERENCE TO RELATED APPLICATIONS

This application is a continuation-in-part of U.S. patent application Ser. No. 10/731,729 filed Dec. 9, 2003, the content of which is incorporated by reference.

### BACKGROUND OF INVENTION

1. Field of Invention

The present invention generally relates to fibers, methods of making fibers and to products made thereof. More particularly, the present invention relates to polypropylene fibers that can comprise syndiotactic polypropylene.

2. Background of the Art

Polypropylene has found employment in a wide variety of applications. Examples of uses include nonwoven fabrics such as spun bonded, melt blown, thermally bonded and carded staple fibers uses for applications such as diaper components and medical fabrics where properties such as bulk and softness are important. Polypropylene fibers have found commercial use in synthetic carpets, geotextiles, textile fabrics and the like. While polypropylene fibers have found wide application as carpet yarns, polypropylene-fibers may lack the elasticity and resiliency of other carpet fiber polymers, for example, nylon. When loads such as furniture legs rest on polypropylene carpets for an extended period are removed, they may leave their impression on the carpet in the form of packed carpet fibers. Poor resiliency prevents the packed fibers from returning back to their original configuration, which may be referred to as elastic recovery.

Bicomponent fibers may comprise a first polymer component and a second component, with each component fused to the other along the fiber axis. The first and second components may be configured as core and sheath, side by side, tipped, (micro) denier and mixed fibers, and are generally produced utilizing a specially equipped fiber spinning machine. Examples of bicomponent fibers include nylon and polyurethane, and polypropylene and polyethylene copolymers.

### SUMMARY OF THE INVENTION

In one aspect, the invention is a bicomponent fiber including a first component and a second component fused together in a side-by-side arrangement wherein the first component includes a syndiotactic polypropylene homopolymer and the second component includes an ethylene propylene random copolymer.

In another aspect, the invention is a method of making a fiber include extruding a first fiber component and a second fiber component and fusing together the first component and the second component into a side-by-side arrangement to form a bicomponent fiber wherein the first component comprises a syndiotactic polypropylene homopolymer and the second component comprises an ethylene-propylene random copolymer.

In still another aspect, the invention is an article of manufacture comprising bicomponent fibers made by a method of making a fiber include extruding a first fiber component and a second fiber component and fusing together the first component and the second component into a side-by-side arrangement to form a bicomponent fiber wherein the first component comprises a syndiotactic polypropylene homopolymer and the second component comprises an ethylene-propylene random copolymer.

Another aspect of the present invention is a nonwoven fabric including at least 5 wt % of a bicomponent fiber of ethylene-propylene random copolymer and syndiotactic polypropylene, the bicomponent fiber being in a side-by-side arrangement, wherein the bicomponent fiber exhibits shrinkage upon exposure to a heat source resulting in an increase in bulk for the fiber.

### DETAILED DESCRIPTION OF THE INVENTION

The fibers of the present invention may be bicomponent fibers comprising syndiotactic polypropylene as a first component and ethylene-propylene random copolymers (EPRC) as a second component. Syndiotactic and isotactic are terms that describe the steric configuration of polypropylene. For example, the isotactic structure is typically described as having the methyl groups attached to the tertiary carbon atoms of successive monomeric units on the same side of a hypothetical plane through the main chain of the polymer, e.g., the methyl groups are all above or all below the plane. Using the Fischer projection formula, the stereochemical sequence of isotactic polypropylene is described as follows:

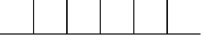

Another way of describing the structure is through the use of NMR spectroscopy. Bovey's NMR nomenclature for an isotactic pentad is . . . mmmm . . . with each “m” representing a “meso” dyad or successive methyl groups on the same side of the plane. As known in the art, any deviation or inversion on the structure of the chain lowers the degree of isotacticity and crystallinity of the polymer.

In contrast to the isotactic structure, syndiotactic polymers are those in which the methyl groups attached to the tertiary carbon atoms of successive monomeric units in the chain lie on alternate sides of the plane of the polymer. Using the Fischer projection formula, the structure of a syndiotactic polymer is designated as:

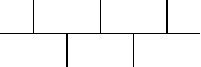

In NMR nomenclature, this pentad is described as . . . rrrr . . . in which each “r” represents a “racemic” dyad, i.e. successive methyl group on alternate sides of the plane. The percentage of r dyads in the chain determines the degree of syndiotacticity of the polymer. Syndiotactic polymers are crystalline and like the isotactic polymers are insoluble in xylene. This crystallinity distinguishes both syndiotactic and isotactic polymers from an atactic polymer which is soluble in xylene.

The syndiotactic polypropylenes suitable for use in the blends of the present invention and methods of making such syndiotactic polypropylenes are well know to those of skill in the polyolefin art. Such materials may be prepared using, for example, Ziegler-Natta and metallocene catalysts. Examples of suitable syndiotactic polypropylenes, methods of and catalysts for their making may be found in U.S. Pat. Nos. 3,258,455, 3,305,538, 3,364,190, 4,852,851, 5,155,080, 5,225,500, 5,334,677 and 5,476,914, all herein incorporated by reference.

Metallocene catalysts may be characterized generally as coordination compounds incorporating one or more cyclopentadienyl (Cp) groups (which may be substituted or unsubstituted, each substitution being the same or different) coordinated with a transition metal through n bonding.

The Cp substituent groups may be linear, branched or cyclic hydrocarbyl radicals. The cyclic hydrocarbyl radicals may further form other contiguous ring structures, including, for example indenyl, azulenyl and fluorenyl groups. These additional ring structures may also be substituted or unsubstituted by hydrocarbyl radicals, such as C₁ to C₂₀ hydrocarbyl radicals.

A specific example of a metallocene catalyst is a bulky ligand metallocene compound generally represented by the formula:
[L]ₘM[A]ₙ
where L is a bulky ligand, A is a leaving group, M is a transition metal and m and n are such that the total ligand valency corresponds to the transition metal valency. For example m may be from 1 to 3 and n may be from 1 to 3.

The metal atom “M” of the metallocene catalyst compound, as described throughout the specification and claims, may be selected from Groups 3 through 12 atoms and lanthanide Group atoms in one embodiment; and selected from Groups 3 through 10 atoms in a more particular embodiment, and selected from Sc, Ti, Zr, Hf, V, Nb, Ta, Mn, Re, Fe, Ru, Os, Co, Rh, Ir, and Ni in yet a more particular embodiment; and selected from Groups 4, 5 and 6 atoms in yet a more particular embodiment, and Ti, Zr, Hf atoms in yet a more particular embodiment, and Zr in yet a more particular embodiment. The oxidation state of the metal atom “M” may range from 0 to +7 in one embodiment; and in a more particular embodiment, is +1, +2, +3, +4 or +5; and in yet a more particular embodiment is +2, +3 or +4. The groups bound the metal atom “M” are such that the compounds described below in the formulas and structures are electrically neutral, unless otherwise indicated.

The bulky ligand generally includes a cyclopentadienyl group (Cp) or a derivative thereof. The Cp ligand(s) form at least one chemical bond with the metal atom M to form the “metallocene catalyst compound”. The Cp ligands are distinct from the leaving groups bound to the catalyst compound in that they are not highly susceptible to substitution/abstraction reactions.

Cp typically includes 7-bonded and/or fused ring(s) or ring systems. The ring(s) or ring system(s) typically include atoms selected from group 13 to 16 atoms, for example, carbon, nitrogen, oxygen, silicon, sulfur, phosphorous, germanium, boron, aluminum and combinations thereof, wherein carbon makes up at least 50% of the ring members. Non-limiting examples include cyclopentadienyl, cyclopentaphenanthreneyl, indenyl, benzindenyl, fluorenyl, tetrahydroindenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl, or “H₄Ind”), substituted versions thereof, and heterocyclic versions thereof.

Cp substituent groups may include hydrogen radicals, alkyls, alkenyls, alkynyls, cycloalkyls, aryls, acyls, aroyls, alkoxys, aryloxys, alkylthiols, dialkylamines, alkylamidos, alkoxycarbonyls, aryloxycarbonyls, carbomoyls, alkyl- and dialkyl-carbamoyls, acyloxys, acylaminos, aroylaminos, and combinations thereof. More particular non-limiting examples of alkyl substituents include methyl, ethyl, propyl, butyl, pentyl, hexyl, cyclopentyl, cyclohexyl, benzyl, phenyl, methylphenyl, and tert-butylphenyl groups and the like, including all their isomers, for example tertiary-butyl, isopropyl, and the like. Other possible radicals include substituted alkyls and aryls such as, for example, fluoromethyl, fluroethyl, difluroethyl, iodopropyl, bromohexyl, chlorobenzyl and hydrocarbyl substituted organometalloid radicals including trimethylsilyl, trimethylgermyl, methyldiethylsilyl and the like; and halocarbyl-substituted organometalloid radicals including tris(trifluoromethyl)silyl, methylbis(difluoromethyl)silyl, bromomethyldimethylgermyl and the like; and disubstituted boron radicals including dimethylboron for example; and disubstituted Group 15 radicals including dimethylamine, dimethylphosphine, diphenylamine, methylphenylphosphine, Group 16 radicals including methoxy, ethoxy, propoxy, phenoxy, methylsulfide and ethylsulfide. Other substituents R include olefins such as but not limited to olefinically unsaturated substituents including vinyl-terminated ligands, for example 3-butenyl, 2-propenyl, 5-hexenyl and the like. In one embodiment, at least two R groups, two adjacent R groups in one embodiment, are joined to form a ring structure having from 3 to 30 atoms selected from the group consisting of carbon, nitrogen, oxygen, phosphorous, silicon, germanium, aluminum, boron and combinations thereof. Also, a substituent group R group such as 1-butanyl may form a bonding association to the element M.

Each anionic leaving group is independently selected and may include any leaving group, such as halogen ions, hydrides, C₁ to C₁₂ alkyls, C₂ to C₁₂ alkenyls, C₆ to C₁₂ aryls, C₇ to C₂₀ alkylaryls, C₁ to C₁₂ alkoxys, C₆ to C₁₆ aryloxys, C₇ to C₁₈ alkylaryloxys, C₁ to C₁₂ fluoroalkyls, C₆ to C₁₂ fluoroaryls, and C₁ to C₁₂ heteroatom-containing hydrocarbons and substituted derivatives thereof; hydride, halogen ions, C₁ to C₆ alkylcarboxylates, C₁ to C₆ fluorinated alkylcarboxylates, C₆ to C₁₂ arylcarboxylates, C₇ to C₁₈ alkylarylcarboxylates, C₁ to C₆ fluoroalkyls, C₂ to C₆ fluoroalkenyls, and C₇ to C₁₈ fluoroalkylaryls in yet a more particular embodiment; hydride, chloride, fluoride, methyl, phenyl, phenoxy, benzoxy, tosyl, fluoromethyls and fluorophenyls in yet a more particular embodiment; C₁ to C₁₂ alkyls, C₂ to C₁₂ alkenyls, C₆ to C₁₂ aryls, C₇ to C₂₀ alkylaryls, substituted C₁ to C₁₂ alkyls, substituted C₆ to C₁₂ aryls, substituted C₇ to C₂₀ alkylaryls and C₁ to C₁₂ heteroatom-containing alkyls, C₁ to C₁₂ heteroatom-containing aryls and C₁ to C₁₂ heteroatom-containing alkylaryls in yet a more particular embodiment; chloride, fluoride, C₁ to C₆ alkyls, C₂ to C₆ alkenyls, C₇ to C₁₈ alkylaryls, halogenated C₁ to C₆ alkyls, halogenated C₂ to C₆ alkenyls, and halogenated C₇ to C₁₈ alkylaryls in yet a more particular embodiment; fluoride, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls) in yet a more particular embodiment; and fluoride in yet a more particular embodiment.

Other non-limiting examples of leaving groups include amines, phosphines, ethers, carboxylates, dienes, hydrocarbon radicals having from 1 to 20 carbon atoms, fluorinated hydrocarbon radicals (e.g., —C₆F₅ (pentafluorophenyl)), fluorinated alkylcarboxylates (e.g., CF₃C(O)O^{—}), hydrides and halogen ions and combinations thereof. Other examples of leaving groups include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, dimethylphosphide radicals and the like. In one embodiment, two or more leaving groups form a part of a fused ring or ring system.

L and A may be bridged to one another. A bridged metallocene, for example may, be described by the general formula:
XCp^{A}Cp^{B}MAₙ
wherein X is a structural bridge, Cp^{A} and Cp^{B} each denote a cyclopentadienyl group, each being the same or different and which may be either substituted or unsubstituted, M is a transition metal and A is an alkyl, hydrocarbyl or halogen group and n is an integer between 0 and 4, and either 1 or 2 in a particular embodiment.

Non-limiting examples of bridging groups (X) include divalent hydrocarbon groups containing at least one Group 13 to 16 atom, such as but not limited to at least one of a carbon, oxygen, nitrogen, silicon, aluminum, boron, germanium and tin atom and combinations thereof; wherein the heteroatom may also be C₁ to C₁₂ alkyl or aryl substituted to satisfy neutral valency. The bridging group may also contain substituent groups as defined above including halogen radicals and iron. More particular non-limiting examples of bridging group are represented by C₁ to C₆ alkylenes, substituted C₁ to C₆ alkylenes, oxygen, sulfur, R₂C═, R₂Si═, —Si(R)₂Si(R₂)—, R₂Ge═, RP═ (wherein “═” represents two chemical bonds), where R is independently selected from the group hydride, hydrocarbyl, substituted hydrocarbyl, halocarbyl, substituted halocarbyl, hydrocarbyl-substituted organometalloid, halocarbyl-substituted organometalloid, disubstituted boron, disubstituted Group 15 atoms, substituted Group 16 atoms, and halogen radical; and wherein two or more Rs may be joined to form a ring or ring system. In one embodiment, the bridged metallocene catalyst component has two or more bridging groups (X).

Other non-limiting examples of bridging groups include methylene, ethylene, ethylidene, propylidene, isopropylidene, diphenylmethylene, 1,2-dimethylethylene, 1,2-diphenylethylene, 1,1,2,2-tetramethylethylene, dimethylsilyl, diethylsilyl, methyl-ethylsilyl, trifluoromethylbutylsilyl, bis(trifluoromethyl)silyl, di(n-butyl)silyl, di(n-propyl)silyl, di(i-propyl)silyl, di(n-hexyl)silyl, dicyclohexylsilyl, diphenylsilyl, cyclohexylphenylsilyl, t-butylcyclohexylsilyl, di(t-butylphenyl)silyl, di(p-tolyl)silyl and the corresponding moieties, wherein the Si atom is replaced by a Ge or a C atom; dimethylsilyl, diethylsilyl, dimethylgermyl and/or diethylgermyl.

In another embodiment, the bridging group may also be cyclic, and include 4 to 10 ring members or 5 to 7 ring members in a more particular embodiment. The ring members may be selected from the elements mentioned above, and/or from one or more of B, C, Si, Ge, N and O in a particular embodiment. Non-limiting examples of ring structures which may be present as or part of the bridging moiety are cyclobutylidene, cyclopentylidene, cyclohexylidene, cycloheptylidene, cyclooctylidene and the corresponding rings where one or two carbon atoms are replaced by at least one of Si, Ge, N and O, in particular, Si and Ge. The bonding arrangement between the ring and the Cp groups may be cis-, trans-, or a combination thereof.

The cyclic bridging groups may be saturated or unsaturated and/or carry one or more substituents and/or be fused to one or more other ring structures. If present, the one or more substituents are selected from the group hydrocarbyl (e.g., alkyl such as methyl) and halogen (e.g., F, Cl) in one embodiment. The one or more Cp groups which the above cyclic bridging moieties may optionally be fused to may be saturated or unsaturated and are selected from the group of those having 4 to 10 ring members, more particularly 5, 6 or 7 ring members (selected from the group of C, N, O and S in a particular embodiment) such as, for example, cyclopentyl, cyclohexyl and phenyl. Moreover, these ring structures may themselves be fused such as, for example, in the case of a naphthyl group. Moreover, these (optionally fused) ring structures may carry one or more substituents. Illustrative, non-limiting examples of these substituents are hydrocarbyl (particularly alkyl) groups and halogen atoms.

In one embodiment, the metallocene catalyst includes CpFlu Type catalysts (e.g., a metallocene incorporating a substituted Cp fluorenyl ligand structure) represented by the following formula:
X(CpRₙ¹Rₘ²)(FIRₚ³)
wherein Cp is a cyclopentadienyl group, Fl is a fluorenyl group, X is a structural bridge between Cp and Fl, R¹ is a substituent on the Cp, n is 1 or 2, R² is a substituent on the Cp at a position which is proximal to the bridge, m is 1 or 2, each R³ is the same or different and is a hydrocarbyl group having from 1 to 20 carbon atoms with R³ being substituted on a nonproximal position on the fluorenyl group and at least one other R³ being substituted at an opposed nonproximal position on the fluorenyl group and p is 2 or 4.

In yet another aspect, the metallocene catalyst includes bridged mono-ligand metallocene compounds (e.g., mono cyclopentadienyl catalyst components). In this embodiment, the at least one metallocene catalyst component is a bridged “half-sandwich” metallocene catalyst. In yet another aspect of the invention, the at least one metallocene catalyst component is an unbridged “half sandwich” metallocene.

Described another way, the “half sandwich” metallocenes above are described in U.S. Pat. No. 6,069,213, U.S. Pat. No. 5,026,798, U.S. Pat. No. 5,703,187, and U.S. Pat. No. 5,747,406, including a dimer or oligomeric structure, such as disclosed in, for example, U.S. Pat. No. 5,026,798 and U.S. Pat. No. 6,069,213, which are incorporated by reference herein.

Non-limiting examples of metallocene catalyst components consistent with the description herein include:
cyclopentadienylzirconiumAₙ,
indenylzirconiumAₙ,
(1-methylindenyl)zirconiumAₙ,
(2-methylindenyl)zirconiumAₙ,
(1-propylindenyl)zirconiumAₙ,
(2-propylindenyl)zirconiumAₙ,
(1-butylindenyl)zirconiumAₙ,
(2-butylindenyl)zirconiumAₙ,
methylcyclopentadienylzirconiumAₙ,
tetrahydroindenylzirconiumAₙ,
pentamethylcyclopentadienylzirconiumAₙ,
cyclopentadienylzirconiumAₙ,
pentamethylcyclopentadienyltitaniumAₙ,
tetramethylcyclopentyltitaniumAₙ,
(1,2,4-trimethylcyclopentadienyl)zirconiumAₙ,
dimethylsilyl(1,2,3,4-tetramethylcyclopentadienyl)(cyclopentadienyl)zirconiumAₙ,
dimethylsilyl(1,2,3,4-tetramethylcyclopentadienyl)(1,2,3-trimethylcyclopentadienyl)zirconiumAₙ,
dimethylsilyl(1,2,3,4-tetramethylcyclopentadienyl)(1,2-dimethylcyclopentadienyl)zirconiumAₙ,
dimethylsilyl(1,2,3,4-tetramethylcyclopentadienyl)(2-methylcyclopentadienyl)zirconiumAₙ,
dimethylsilylcyclopentadienylindenylzirconiumAₙ,
dimethylsilyl(2-methylindenyl)(fluorenyl)zirconiumAₙ,
diphenylsilyl(1,2,3,4-tetramethylcyclopentadienyl)(3-propylcyclopentadienyl)zirconiumAₙ,
dimethylsilyl(1,2,3,4-tetramethylcyclopentadienyl)(3-t-butylcyclopentadienyl)zirconiumAₙ,
dimethylgermyl(1,2-dimethylcyclopentadienyl)(3-isopropylcyclopentadienyl)zirconiumAₙ,
dimethylsilyl(1,2,3,4-tetramethylcyclopentadienyl)(3-methylcyclopentadienyl)zirconiumAₙ,
diphenylmethylidene(cyclopentadienyl)(9-fluorenyl)zirconiumAₙ,
diphenylmethylidenecyclopentadienylindenylzirconiumAₙ,
isopropylidenebiscyclopentadienylzirconiumAₙ,
isopropylidene(cyclopentadienyl)(9-fluorenyl)zirconiumAₙ,
isopropylidene(3-methylcyclopentadienyl)(9-fluorenyl)zirconiumAₙ,
ethylenebis(9-fluorenyl)zirconiumAₙ,
mesoethylenebis(1-indenyl)zirconiumAₙ,
ethylenebis(1-indenyl)zirconiumAₙ,
ethylenebis(2-methyl-1-indenyl)zirconiumAₙ,
ethylenebis(2-methyl-4,5,6,7-tetrahydro-1-indenyl)zirconiumAₙ,
ethylenebis(2-propyl-4,5,6,7-tetrahydro-1-indenyl)zirconiumAₙ,
ethylenebis(2-isopropyl-4,5,6,7-tetrahydro-1-indenyl)zirconiumAₙ,
ethylenebis(2-butyl-4,5,6,7-tetrahydro-1-indenyl)zirconiumAₙ,
ethylenebis(2-isobutyl-4,5,6,7-tetrahydro-1-indenyl)zirconiumAₙ,
dimethylsilyl(4,5,6,7-tetrahydro-1-indenyl)zirconiumAₙ,
diphenyl(4,5,6,7-tetrahydro-1-indenyl)zirconiumAₙ,
ethylenebis(4,5,6,7-tetrahydro-1-indenyl)zirconiumAₙ,
dimethylsilylbis(cyclopentadienyl)zirconiumAₙ,
dimethylsilylbis(9-fluorenyl)zirconiumAₙ,
dimethylsilylbis(1-indenyl)zirconiumAₙ,
dimethylsilylbis(2-methylindenyl)zirconiumAₙ,
dimethylsilylbis(2-propylindenyl)zirconiumAₙ,
dimethylsilylbis(2-butylindenyl)zirconiumAₙ,
diphenylsilylbis(2-methylindenyl)zirconiumAₙ,
diphenyisilylbis(2-propylindenyi)zirconiumAₙ,
diphenylsilylbis(2-butylindenyl)zirconiumAₙ,
dimethylgermylbis(2-methylindenyl)zirconiumAₙ,
dimethylsilylbistetrahydroindenylzirconiumAₙ,
dimethylsilylbistetramethylcyclopentadienylzirconiumAₙ,
dimethylsilyl(cyclopentadienyl)(9-fluorenyl)zirconiumAₙ,
diphenyIsilyl(cyclopentadienyl)(9-fluorenyl)zirconiumAₙ,
diphenylsilylbisindenylzirconiumAₙ,
cyclotrimethylenesilyltetramethylcyclopentadienylcyclopentadienylzirconiumAₙ,
cyclotetramethylenesilyltetramethylcyclopentadienylcyclopentadienylzirconiumAₙ,
cyclotrimethylenesilyl (tetramethylcyclopentadienyl )(2-methylindenyl)zirconiumAₙ,
cyclotrimethylenesilyl(tetramethylcyclopentadienyl)(3-methylcyclopentadienyl)zirconiumAₙ,
cyclotrimethylenesilylbis(2-methylindenyl)zirconiumAₙ,
cyclotrimethylenesilyl(tetramethylcyclopentadienyl)(2,3,5-trimethylclopentadienyl)zirconiumAₙ,
cyclotrimethylenesilylbis(tetramethylcyclopentadienyl)zirconiumAₙ,
dimethylsilyl(tetramethylcyclopentadieneyl)(N-tertbutylamido)titaniumAₙ,
biscyclopentadienylchromiumAₙ,
biscyclopentadienylzirconiumAₙ,
bis(n-butylcyclopentadienyl)zirconiumAₙ,
bis(n-dodecyclcyclopentadienyl)zirconiumAₙ,
bisethylcyclopentadienylzirconiumAₙ,
bisisobutylcyclopentadienylzirconiumAₙ,
bisisopropylcyclopentadienylzirconiumAₙ,
bismethylcyclopentadienylzirconiumAₙ,
bisnoxtylcyclopentadienylzirconiumAₙ,
bis(n-pentylcyclopentadienyl)zirconiumAₙ,
bis(n-propylcyclopentadienyl)zirconiumAₙ,
bistrimethylsilylcyclopentadienylzirconiumAₙ,
bis(1,3-bis(trimethylsilyl)cyclopentadienyl)zirconiumAₙ,
bis(1-ethyl-2-methylcyclopentadienyl)zirconiumAₙ,
bis(1-ethyl-3-methylcyclopentadienyl)zirconiumAₙ,
bispentamethylcyclopentadienylzirconiumAₙ,
bispentamethylcyclopentadienylzirconiumAₙ,
bis(1-propyl-3-methylcyclopentadienyl)zirconiumAₙ,
bis(1-n-butyl-3-methylcyclopentadienyl)zirconiumAₙ,
bis(1-isobutyl-3-methylcyclopentadienyl)zirconiumAₙ,
bis(1-propyl-3-butylcyclopentadienyl)zirconiumAₙ,
bis(1,3-n-butylcyclopentadienyl)zirconiumAₙ,
bis(4,7-dimethylindenyl)zirconiumAₙ,
bisindenylzirconiumAₙ,
bis(2-methylindenyl)zirconiumAₙ,
cyclopentadienylindenylzirconiumAₙ,
bis(n-propylcyclopentadienyl)hafniumAₙ,
bis(n-butylcyclopentadienyl)hafniumAₙ,
bis(n-pentylcyclopentadienyl)hafniumAₙ,
(n-propylcyclopentadienyl)(n-butylcyclopentadienyl)hafniumAₙ,
bis[(2-trimethylsilylethyl)cyclopentadienyl]hafniumAₙ,
bis(trimethylsilylcyclopentadienyl)hafniumAₙ,
bis(2-n-propylindenyl)hafniumAₙ,
bis(2-n-butylindenyl)hafniumAₙ,
dimethylsilylbis(n-propylcyclopentadienyl)hafniumAₙ,
dimethylsilylbis(n-butylcyclopentadienyl)hafniumAₙ,
bis(9-n-propylfluorenyl)hafniumAₙ,
bis(9-n-butylfluorenyl)hafniumAₙ,
(9-n-propylfluorenyl)(2-n-propylindenyl)hafniumAₙ,
bis(1-n-propyl-2-methylcyclopentadienyl)hafniumAₙ,
(n-propylcyclopentadienyl)(1-n-propyl-3-n-butylcyclopentadienyl)hafniumAₙ,
dimethylsilyltetramethylcyclopentadienylcyclopropylamidotitaniumAₙ,
dimethylsilyltetramethylcyclopentadienylcyclobutylamidotitaniumAₙ,
dimethylsilyltetramethylcyclopentadienylcyclopentylamidotitaniumAₙ,
dimethylsilyltetramethylcyclopentadienylcyclohexylamidotitaniumAₙ,
dimethylsilyltetramethylcyclopentadienylcycloheptylamidotitaniumAₙ,
dimethylsilyltetramethylcyclopentadienylcyclooctylamidotitaniumAₙ,
dimethylsilyltetramethylcyclopentadienylcyclononylamidotitaniumAₙ,
dimethylsilyltetramethylcyclopentadienylcyclodecylamidotitaniumAₙ,
dimethylsilyltetramethylcyclopentadienylcycloundecylamidotitaniumAₙ,
dimethylsilyltetramethylcyclopentadienylcyclododecylamidotitaniumAₙ,
dimethylsilyltetramethylcyclopentadienyl(sec-butylamido)titaniumAₙ,
dimethylsilyl(tetramethylcyclopentadienyl)(n-octylamido)titaniumAₙ,
dimethylsilyl(tetramethylcyclopentadienyl)(n-decylamido)titaniumAₙ,
dimethylsilyl(tetramethylcyclopentadienyl)(n-octadecylamido)titaniumAₙ,
methylphenylsilyltetramethylcyclopentadienylcyclopropylamidotitaniumAₙ,
methylphenylsilyltetramethylcyclopentadienylcyclobutylamidotitaniumAₙ,
methylphenylsilyltetramethylcyclopentadienylcyclopentylamidotitaniumAₙ,
methylphenylsilyltetramethylcyclopentadienylcyclohexylamidotitaniumAₙ,
methylphenylsilyltetramethylcyclopentadienylcycloheptylamidotitaniumAₙ,
methylphenylsilyltetramethylcyclopentadienylcyclooctylamidotitaniumAₙ,
methylphenylsilyltetramethylcyclopentadienylcyclononylamidotitaniumAₙ,
methylphenylsilyltetramethylcyclopentadienylcyclodecylamidotitaniumAₙ,
methylphenylsilyltetramethylcyclopentadienylcycloundecylamidotitaniumAₙ,
methylphenylsilyltetramethylcyclopentadienylcyclododecylamidotitaniumAₙ,
methylphenylsilyl(tetramethylcyclopentadienyl)(sec-butylamido)titaniumAₙ,
methylphenylsilyl(tetramethylcyclopentadienyl)(n-octylamido)titaniumAₙ,
methylphenyisilyi(tetramethylcyclopentadienyl)(n-decylamido)titaniumAₙ,
methylphenylsilyi(tetramethylcyclopentadienyl)(n-octadecylamido)titaniumAₙ,
diphenylsilyltetramethylcyclopentadienylcyclopropylamidotitaniumAₙ,
diphenylsilyltetramethylcyclopentadienylcyclobutylamidotitaniumAₙ,
diphenylsilyltetramethylcyclopentadienylcyclopentylamidotitaniumAₙ,
diphenylsilyltetramethylcyclopentadienylcyclohexylamidotitaniumAₙ,
diphenylsilyltetramethylcyclopentadienylcycloheptylamidotitaniumAₙ,
diphenylsilyltetramethylcyclopentadienylcyclooctylamidotitaniumAₙ,
diphenylsilyltetramethylcyclopentadienylcyclononylamidotitaniumAₙ,
diphenylsilyltetramethylcyclopentadienylcyclodecylamidotitaniumAₙ,
diphenylsilyltetramethylcyclopentadienylcycloundecylamidotitaniumAₙ,
diphenylsilyltetramethylcyclopentadienylcyclododecylamidotitaniumAₙ,
diphenylsilyl(tetramethylcyclopentadienyl)(sec-butylamido)titaniumAₙ,
diphenylsilyl(tetramethylcyclopentadienyl)(n-octylamido)titaniumAₙ,
diphenylsilyl(tetramethylcyclopentadienyl)(n-decylamido)titaniumAₙ,
diphenylsilyl(tetramethylcyclopentadienyl)(n-octadecylamido)titaniumAₙ, and derivatives thereof.

As used herein, the term “metallocene activator” is defined to be any compound or combination of compounds, supported or unsupported, which may activate a single-site catalyst compound (e.g., metallocenes, Group 15 containing catalysts, etc.) Typically, this involves the abstraction of at least one leaving group (A group in the formulas/structures above, for example) from the metal center of the catalyst component. The catalyst components of the present invention are thus activated towards olefin polymerization using such activators. Embodiments of such activators include Lewis acids such as cyclic or oligomeric polyhydrocarbylaluminum oxides and so called non-coordinating ionic activators (“NCA”), alternately, “ionizing activators” or “stoichiometric activators”, or any other compound that may convert a neutral metallocene catalyst component to a metallocene cation that is active with respect to olefin polymerization.

More particularly, it is within the scope of this invention to use Lewis acids such as alumoxane (e.g., “MAO”), modified alumoxane (e.g., “TIBAO”), and alkylaluminum compounds as activators, to activate desirable metallocenes described herein. MAO and other aluminum-based activators are well known in the art. Non-limiting examples of aluminum alkyl compounds which may be utilized as activators for the catalysts described herein include trimethylaluminum, triethylaluminum, triisobutylaluminum, tri-n-hexylaluminum, tri-n-octylaluminum and the like.

Ionizing activators are well known in the art and are described by, for example, Eugene You-Xian Chen & Tobin J. Marks, Cocatalysts for Metal-Catalyzed Olefin Polymerization: Activators, Activation Processes, and Structure-Activity Relationships 100(4) CHEMICAL REVIEWS 1391-1434 (2000). Examples of neutral ionizing activators include Group 13 tri-substituted compounds, in particular, tri-substituted boron, tellurium, aluminum, gallium and indium compounds, and mixtures thereof (e.g., tri(n-butyl)ammonium tetrakis(pentafluorophenyl)boron and/or trisperfluorophenyl boron metalloid precursors). The three substituent groups are each independently selected from alkyls, alkenyls, halogen, substituted alkyls, aryls, arylhalides, alkoxy and halides. In one embodiment, the three groups are independently selected from the group of halogen, mono or multicyclic (including halosubstituted) aryls, alkyls, and alkenyl compounds and mixtures thereof. In another embodiment, the three groups are selected from the group alkenyl groups having 1 to 20 carbon atoms, alkyl groups having 1 to 20 carbon atoms, alkoxy groups having 1 to 20 carbon atoms and aryl groups having 3 to 20 carbon atoms (including substituted aryls), and combinations thereof. In yet another embodiment, the three groups are selected from the group alkyls having 1 to 4 carbon groups, phenyl, naphthyl and mixtures thereof. In yet another embodiment, the three groups are selected from the group highly halogenated alkyls having 1 to 4 carbon groups, highly halogenated phenyls, and highly halogenated naphthyls and mixtures thereof. By “highly halogenated”, it is meant that at least 50% of the hydrogens are replaced by a halogen group selected from fluorine, chlorine and bromine. In yet another embodiment, the neutral stoichiometric activator is a tri-substituted Group 13 compound comprising highly fluorided aryl groups, the groups being highly fluorided phenyl and highly fluorided naphthyl groups.

Illustrative, not limiting examples of ionic ionizing activators include trialkyl-substituted ammonium salts such as:
triethylammoniumtetraphenylboron,
tripropylammoniumtetraphenylboron,
tri(n-butyl)ammoniumtetraphenylboron,
trimethylammoniumtetra(p-tolyl)boron,
trimethylammoniumtetra(o-tolyl)boron,
tributylammoniumtetra(pentafluorophenyl)boron,
tripropylammoniumtetra(o,p-dimethylphenyl)boron,
tributylammoniumtetra(m,m-dimethylphenyl)boron,
tributylammoniumtetra(p-tri-fluoromethylphenyl)boron,
tributylammoniumtetra(pentafluorophenyl)boron,
tri(n-butyl)ammoniumtetra(o-tolyl)boron, and the like;
N,N-dialkylanilinium salts such as:
N,N-dimethylaniliniumtetraphenylboron,
N,N-diethylaniliniumtetraphenylboron,
N,N-2,4,6-pentamethylaniliniumtetraphenylboron and the like;
dialkyl ammonium salts such as:
diisopropylammoniumtetrapentafluorophenylboron,
dicyclohexylammoniumtetraphenylboron and the like;
triaryl phosphonium salts such as:
triphenylphosphoniumtetraphenylboron,
trimethylphenylphosphoniumtetraphenylboron,
tridimethylphenylphosphoniumtetraphenylboron and the like, and their aluminum equivalents.

In yet another embodiment, an alkylaluminum may be used in conjunction with a heterocyclic compound. The ring of the heterocyclic compound may include at least one nitrogen, oxygen, and/or sulfur atom, and includes at least one nitrogen atom in one embodiment. The heterocyclic compound includes 4 or more ring members in one embodiment, and 5 or more ring members in another embodiment.

The heterocyclic compound for use as an activator with an alkylaluminum may be unsubstituted or substituted with one or a combination of substituent groups. Examples of suitable substituents include halogen, alkyl, alkenyl or alkynyl radicals, cycloalkyl radicals, aryl radicals, aryl substituted alkyl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl- carbamoyl radicals, acyloxy radicals, acylamino radicals, aroylamino radicals, straight, branched or cyclic, alkylene radicals, or any combination thereof. The substituents groups may also be substituted with halogens, particularly fluorine or bromine, or heteroatoms or the like.

Non-limiting examples of hydrocarbon substituents include methyl, ethyl, propyl, butyl, pentyl, hexyl, cyclopentyl, cyclohexyl, benzyl or phenyl groups and the like, including all their isomers, for example tertiary butyl, isopropyl, and the like. Other examples of substituents include fluoromethyl, fluoroethyl, difluoroethyl, iodopropyl, bromohexyl or chlorobenzyl.

In one embodiment, the heterocyclic compound is unsubstituted. In another embodiment one or more positions on the heterocyclic compound are substituted with a halogen atom or a halogen atom containing group, for example a halogenated aryl group. In one embodiment the halogen is selected from the group consisting of chlorine, bromine and fluorine, and selected from the group consisting of fluorine and bromine in another embodiment, and the halogen is fluorine in yet another embodiment.

Non-limiting examples of heterocyclic compounds utilized in the activator of the invention include substituted and unsubstituted pyrroles, imidazoles, pyrazoles, pyrrolines, pyrrolidines, purines, carbazoles, and indoles, phenyl indoles, 2,5,-dimethylpyrroles, 3-pentafluorophenylpyrrole, 4,5,6,7-tetrafluoroindole or 3,4-difluoropyrroles.

In one embodiment, the heterocyclic compound described above is combined with an alkyl aluminum or an alumoxane to yield an activator compound which, upon reaction with a catalyst component, for example a metallocene, produces an active polymerization catalyst. Non-limiting examples of alkylaluminums include trimethylaluminum, triethylaluminum, triisobutylaluminum, tri-n-hexylaluminum, tri-n-octylaluminum, tri-iso-octylaluminum, triphenylaluminum, and combinations thereof.

Other activators include those described in WO 98/07515 such as tris (2, 2′, 2″-nonafluorobiphenyl) fluoroaluminate, which is incorporated by reference herein. Combinations of activators are also contemplated by the invention, for example, alumoxanes and ionizing activators in combinations. Other activators include aluminum/boron complexes, perchlorates, periodates and iodates including their hydrates; lithium (2,2′-bisphenyl-ditrimethylsilicate)4T-HF; silylium salts in combination with a non-coordinating compatible anion. Also, methods of activation such as using radiation, electrochemical oxidation, and the like are also contemplated as activating methods for the purposes of rendering the neutral metallocene-type catalyst compound or precursor to a metallocene-type cation capable of polymerizing olefins. Other activators or methods for activating a metallocene-type catalyst compound are described in for example, U.S. Pat. Nos. 5,849,852, 5,859,653 and 5,869,723 and WO 98/32775.

In general, the activator and catalyst component(s) are combined in mole ratios of activator to catalyst component from 1000:1 to 0.1:1 in one embodiment, and from 300:1 to 1:1 in a more particular embodiment, and from 150:1 to 1:1 in yet a more particular embodiment, and from 50:1 to 1:1 in yet a more particular embodiment, and from 10:1 to 0.5:1 in yet a more particular embodiment, and from 3:1 to 0.3:1 in yet a more particular embodiment, wherein a desirable range may include any combination of any upper mole ratio limit with any lower mole ratio limit described herein. When the activator is a cyclic or oligomeric poly(hydrocarbylaluminum oxide) (e.g., “MAO”), the mole ratio of activator to catalyst component ranges from 2:1 to 100,000:1 in one embodiment, and from 10:1 to 10,000:1 in another embodiment, and from 50:1 to 2,000:1 in a more particular embodiment. When the activator is a neutral or ionic ionizing activator such as a boron alkyl and the ionic salt of a boron alkyl, the mole ratio of activator to catalyst component ranges from 0.5:1 to 10:1 in one embodiment, and from 1:1 to 5:1 in yet a more particular embodiment.

More particularly, the molar ratio of Al/metallocene-metal (Al from MAO) ranges from 40 to 500 in one embodiment, ranges from 50 to 400 in another embodiment, ranges from 60 to 300 in yet another embodiment, ranges from 70 to 200 in yet another embodiment, ranges from 80 to 175 in yet another embodiment; and ranges from 90 to 125 in yet another embodiment, wherein a desirable molar ratio of Al(MAO) to metallocene-metal “M” may be any combination of any upper limit with any lower limit described herein.

The activators may or may not be associated with or bound to a support, either in association with the catalyst component (e.g., metallocene) or separate from the catalyst component, such as described by Gregory G. Hlatky, Heterogeneous Single-Site Catalysts for Olefin Polymerization 100(4) CHEMICAL REVIEWS 1347-1374 (2000).

Metallocene Catalysts may be supported or unsupported. Typical support materials may include talc, inorganic oxides, clays and clay minerals, ion-exchanged layered compounds, diatomaceous earth compounds, zeolites or a resinous support material, such as a polyolefin.

Specific inorganic oxides include silica, alumina, magnesia, titania and zirconia, for example. The inorganic oxides used as support materials may have an average particle size of from 30 microns to 600 microns, or from 30 microns to 100 microns, a surface area of from 50 m²/g to 1,000 m²/g, or from 100 m²/g to 400 m²/g, a pore volume of from 0.5 cc/g to 3.5 cc/g, or from 0.5 cc/g to 2 cc/g.

Desirable methods for supporting metallocene ionic catalysts are described in U.S. Pat. Nos. 5,643,847; 09,184,358 and 09,184,389, which are incorporated by reference herein. The methods generally include reacting neutral anion precursors that are sufficiently strong Lewis acids with the hydroxyl reactive functionalities present on the silica surface such that the Lewis acid becomes covalently bound.

When the activator for the metallocene supported catalyst composition is a NCA, desirably the NCA is first added to the support composition followed by the addition of the metallocene catalyst. When the activator is MAO, desirably the MAO and metallocene catalyst are dissolved together in solution. The support is then contacted with the MAO/metallocene catalyst solution. Other methods and order of addition will be apparent to those skilled in the art

Those skilled in the art will appreciate that modifications in the above generalized preparation method may be made without altering the outcome. Therefore, it will be understood that additional description of methods and means of preparing the catalyst are outside of the scope of the invention, and that it is only the identification of the prepared catalysts, as defined herein, that is necessarily described herein.

The syndiotactic polypropylene utilized in the present invention may comprise at least 70 percent syndiotactic molecules. In alternate embodiments of the invention the syndiotactic polypropylene utilized in the present invention comprises at least 75 percent syndiotactic molecules, at least 80 percent syndiotactic molecules and at least about 83 percent syndiotactic molecules. It may be desirable to have the syndiotactic polypropylene utilized in the present invention comprising substantially all syndiotactic molecules.

In alternate embodiments of the invention the syndiotactic polypropylenes utilized generally comprise in the range of about 83 to about 95 percent syndiotactic molecules, in the range of about 85 to about 95 percent syndiotactic molecules and it may be desirable to be in the range of about 89 to about 95 percent syndiotactic molecules.

The syndiotactic polypropylenes utilized in the present invention generally have a melt flow rate in the range of about 4 to about 2000 dg/min. For use in some woven applications, the syndiotactic polypropylenes may have a melt flow rate in the range of about 4 to about 40 dg/min, and it may be desirable for the MFR to be in the range of about 4 to about 30 dg/min. For use in some non-woven applications, the syndiotactic polypropylenes may have a melt flow rate in the range of about 30 to about 2000 dg/min. It should be noted that the polypropylene homopolymers useful herein may include small amounts of ethylene, usually much less than 1 percent by weight.

Examples of commercially available syndiotactic polypropylene homopolymers are polymers known as EOD 93-06 and EOD 93-07 are available from Total Petrochemicals.

The EPRC may be an isotactic propylene copolymer, a syndiotactic propylene copolymer, or a blend of isotactic and syndiotactic propylene copolymers. The EPRC comprises a random EPRC which, in one embodiment, is prepared using a metallocene catalyst to have a melt-flow rate of from about 20 to about 100 g/10 minutes at 230° C./2.1 Kg.

In another embodiment, the EPRC is prepared using a Ziegler-Natta catalyst. Desirably, the EPRC prepared having a melt flow rate of from about 0.5 to 6 g/10 minutes at 230° C./2.1 Kg and then is compounded with visbreaking materials, such as peroxides, to have a melt-flow rate of from about 25 to 100 g/10 minutes at 230° C./2.1 Kg.

The EPRCs may have a monomodal molecular weight distribution or a multimodal molecular weight distribution, for example a bimodal molecular weight distribution. The EPRC may contain from 0.1 to up to 3 wt % ethylene. The EPRC may be a random block copolymer, but desirably is a substantially non-block random copolymer as is produced in metallocene catalyzed copolymer processes.

The bicomponent fibers of the present invention may comprise a syndiotactic polypropylene component and an EPRC component with each component fused to the other along the fiber axis. The bicomponent fibers of the present invention may be any type of bicomponent fiber. Non-limiting examples of bicomponent fibers that may be utilized in the present invention include various embodiments of side-by-side fibers.

The first component of the bicomponent fiber of the present invention will generally comprise in the range of about 20 to about 80 weight percent of the fiber. The second component will generally comprise in the range of about 80 to 20 weight percent of the fiber based on the weight of the first component and the second component.

Where fiber shrinkage is desired, it may be desirable to utilize fibers having EPRC/sPP components in the side/side arrangement. The shrinkage of bicomponent fibers may be increased or decreased by adding more or less of sPP, respectively. Possible end use applications for this high shrinkage fiber may include a nonwoven textile material, a diaper, a feminine hygiene product, a drape, a gown, a mask, a glove, or an absorbent pad. The components may comprise differing physical characteristics that may alter the appearance of the article or application, such as for example, each of the components comprise a different color, thereby blending the two colors throughout a carpet material by way of each individual fiber.

The high-shrinkage EPRC/sPP fibers may be used as a replacement for acrylic fibers in many end uses including non-woven fabrics. The bicomponent fiber may be blended at a level of 30-50% with the standard product. On exposure to a heat source, such as heated water or air, the high-bulk bicomponent fibers shrink so that bulk is developed in the standard, non-shrinkable portion of the carpet. Typically the heat source will be at least 100° C., and may be at temperatures of at least 120° C. It may be desirable to have the heat source between 110° C. and 150° C.

The heat source may be a variety of means such as, for example, heated air, steam, heated drums, etc. The temperature of the heat source is related to 1) the heat transfer coefficient of the heating medium (air, water, steam), 2) the diameter of the fibers, 3) the residence time during which the fiber is heated, and 4) the relative melting points for the two materials of the bicomponent fibers. The melting points of the materials may vary, for example, sPP may range from about 110° C. to about 130° C., versus EPRC that may range from about 160 to 166° C. The bulk temperature of the fibers may be used as a process control parameter. It is desirable to keep the bulk temperature of the fibers below the melting point of the EPRC component, for example less than 163° C. or in alternate embodiments less than 160° C., less than 150° C., or less than 140° C.

The fibers of the invention are believed to be useful as substitutes for prior art fibers. Non-limiting examples of suitable applications include nonwoven fabrics.

The fibers of the invention have improved softness in comparison to polypropylene homopolymer fibers. This can be an advantage in applications such as diapers where a nonwoven fabric prepared using the invention is in contact with skin, particularly sensitive areas of the body. One useful embodiment of the fibers of the present invention are staple fibers wherein the fibers are stretched when prepared and then chopped into lengths of up to about 4 inches for use in applications such as non-woven fabrics. In another embodiment, a bicomponent fiber of the invention may function as a binding fiber where the bicomponent fiber is heated in the presence of other fibers above the softening point of at least one of the two components of the bicomponent fiber. The softened portion of the bicomponent fiber may then serve to bind the other fibers together in one embodiment, or compatibilize fibers in another embodiment.

The components of a bicomponent fiber may be joined in a symmetric or asymmetric arrangement. Generally, the spinning of bicomponent fibers involves coextrusion of two different polymers to form several single filaments. Bicomponent fiber extrusion equipment may be utilized to bring together the two component melt streams in a desired predetermined arrangement. Such bicomponent fiber extrusion equipment is known in the art.

The fibers of the present invention may optionally also contain conventional ingredients as are known to those of skill in the art. Non-limiting examples of such conventional ingredients include, antistatic agents, antioxidants, crystallization aids, colorants, dyes, flame retardants, fillers, impact modifiers, release agents, oils, other polymers, pigments, processing agents, reinforcing agents, stabilizers, UV resistance agents, antifogging agents, wetting agents and the like. Desirably primary antioxidants, process stabilizers, and catalyst neutralizers may be incorporated into the bicomponent fibers of the invention.

1. A bicomponent fiber comprising a first component and a second component fused together in a side-by-side arrangement wherein the first component comprises a syndiotactic polypropylene homopolymer and the second component comprises an ethylene propylene random copolymer.

2. The fiber of claim 1 wherein the first component comprises about 20 to about 80 weight percent of the fiber and the second component comprises about 20 to about 80 weight percent of the fiber.

3. The fiber of claim 1 wherein the first component and the second component have different melt flow rates.

4. The fiber of claim 1 wherein the fiber exhibits self-crimp properties when exposed to an elevated temperature.

5. The fiber of claim 4 wherein the fiber exhibits increased bulk resulting from the self-crimp properties.

6. The fiber of claim 1 wherein the first component comprises a first melting temperature and the second component comprises a different melting temperature and the fiber is heated to a temperature that is between the melting temperature of the first and second component.

7. The fiber of claim 1 wherein the first component is present at 20 weight percent.

8. The fiber of claim 1 wherein the fiber comprises from about 40 to about 60% of syndiotactic polypropylene homopolymer or ethylene-propylene random copolymer.

9. The fiber of claim 8 wherein the fiber comprises about 50% of syndiotactic polypropylene homopolymer or ethylene-propylene random copolymer.

10. The fiber of claim 1 wherein the amount of fiber shrinkage may be may be increased or decreased by adding more or less of syndiotactic polypropylene homopolymer or ethylene-propylene random copolymer, respectively.

11. A method of making a fiber comprising extruding a first fiber component and a second fiber component and fusing together the first component and the second component into a side-by-side arrangement to form a bicomponent fiber wherein the first component comprises a syndiotactic polypropylene homopolymer and the second component comprises an ethylene-propylene random copolymer.

12. The method of claim 11 wherein the first component comprises from about 20 to about 80 weight percent of the fiber and the second component comprises in the range of about 20 to about 80 weight percent of the fiber.

13. The method of claim 11 wherein the first component and the second component have different melt flow rates.

14. The method of claim 11 further comprising exposing the bicomponent fiber to a heat source, wherein the bicomponent fiber exhibits self-crimp properties.

15. The method of claim 14 further comprising using the bicomponent fiber to manufacture carded staple fiber, spunbonded fiber or melt blown fibers.

16. The method of claim 11 wherein the first component is present at 20 weight percent.

17. An article of manufacture comprising bicomponent fibers made by the method of claim 11.

18. The article of claim 17 wherein the article selected from the group consisting of textile materials, upholstery fabrics, wallcoverings, thermal and acoustical insulation, roofing materials and geotextiles, diaper coverstock and related diaper components, hygiene-related fabrics, medical and surgical wraps, drapes, and gowns and protective clothing, filtration media, wipes and absorbent pads.

19. A nonwoven fabric comprising at least 5 wt % of a bicomponent fiber of ethylene-propylene random copolymer and syndiotactic polypropylene, the bicomponent fiber being in a side-by-side arrangement, wherein the bicomponent fiber exhibits shrinkage upon exposure to a heat source resulting in an increase in bulk for the fiber.

20. The nonwoven fabric of claim 19 wherein the bicomponent fiber of ethylene-propylene random copolymer and syndiotactic polypropylene fiber is a binder fiber.
